(19) United States
(12) Patent Application Publication
(10) Pub. No.: US 2010/0268617 A1
(43) Pub. Date: Oct. 21, 2010

(54) WEB-BASED PURCHASE ORDER PROCESSOR

(75) Inventor: Troy Richard Broitzman, Mound, MN (US)

Correspondence Address: Troy Broitzman, PO BOX 249057, Coral Gables, FL, 33146-9057, US

(73) Assignee: LED Bulb, L.L.C., Long Lake, MN (US)

(21) Appl. No.: 12/754,847

(22) Filed: Apr. 6, 2010

Related U.S. Application Data
(60) Provisional application No. 61/214,017, filed on Apr. 17, 2009.

(51) Int. Cl. G06Q 30/00; G06Q 10/00

(52) U.S. Cl. 705/26

(57) ABSTRACT

The present invention is directed generally to internet-based commerce, and more particularly to a method to real-time track purchase orders and aggregate similar archived purchasing agents inputs and utilize this information to reduce the customer selling price of goods and services.

### CROSS-REFERENCE TO RELATED APPLICATIONS

The present application claim the benefit of and priority to U.S. Provisional Application Ser. No. 61/214,017 Filed the 17^{th} of April, 2009 the entire content of which being incorporated herein by reference.

### FIELD OF THE INVENTION

The present invention is directed generally to internet-based commerce, and more particularly to a method to real-time track purchase orders and aggregate similar archived purchasing agents inputs and utilize this information to reduce the customer selling price of goods and services.

### BACKGROUND

More and more people are purchasing goods and services electronically over the Internet. In one instance, these mechanisms provide an outlet for suppliers having surplus inventory, and often allow purchasers to obtain desired goods or services at below-market rates. One common example of an electronic exchange between purchasers and suppliers is the “electronic travel agent,” used to place an offer for travel accommodations, such as hotel rooms or airline tickets. However, existing electronic exchanges suffer from various problems. For instance, schemes employed by existing systems to satisfy offers from purchasers with quotes from suppliers do not create an incentive for the suppliers to quote their goods or services at rates significantly below market rates because the suppliers cannot benefit from quoting generally such low rates. One reason is that existing systems satisfy a purchaser's offer by simply querying a list of suppliers to determine whether one or more of them can provide accommodations at a given rate, based on the offer value. The first qualified supplier that satisfies the offer is selected as the winner of the offer, even if the selected supplier does not quote the lowest rate. There is no incentive for a supplier to quote a lower rate.

In addition, existing schemes charge a purchaser the value of the purchaser's offer even if that value exceeds what the purchaser would have paid without the aid of the electronic travel service system. In other words, even if the purchaser's offer exceeds a published rate for the accommodations, existing schemes punish the purchaser by charging them the full value of the offer. Even more, the current state of the art in interne purchasing does not benefit the general buying public in total—each sale is an individual event and does not gauge the overall consumer's buying interest in a particular product, which could benefit both buyer and seller if the real-time supply-demand information was available.

### SUMMARY OF THE INVENTION

Generally, the present invention is directed to internet-based commerce, and more particularly to a method to real-time track purchase orders and aggregate similar archived purchasing agents inputs and utilize this information to reduce the customer selling price of goods and service

One embodiment of the present invention describes a method for processing a request to purchase goods at a specific bid price including a processor to accept said request to purchase goods over the Internet, said processor in real-time contact with vendors to calculate current list price for purchasable goods, said processor to accumulate multiple requests to purchase similar goods, said processor in real-time contacts vendors to request volume discount on purchasable goods, and, said processor to accept request to purchase goods at a specific bid price when bid price meets or exceeds current list price.

The above summary of the present invention is not intended to describe each illustrated embodiment or every implementation of the present invention. The figures and the detailed description which follow, more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a flowchart representation of one embodiment of the present invention depicting in steps 100 thru 700 a web-based purchase order processor.

FIG. 2 shows a flowchart continuation of FIG. 1 depicting in steps 800 thru 1000 a web-based purchase order processor.

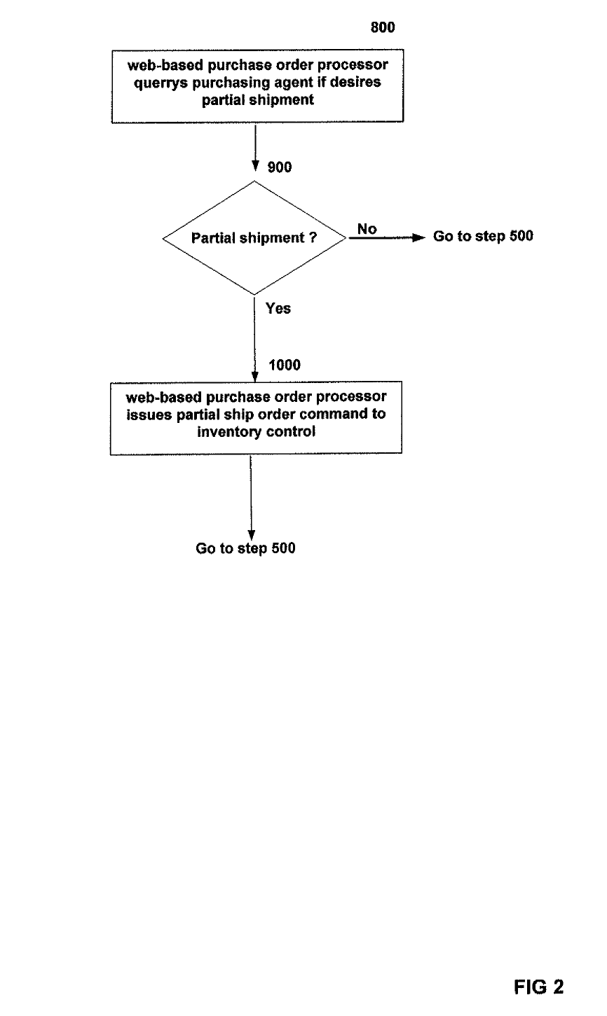

### DETAILED DESCRIPTION

In general, the present invention is directed generally to internet-based commerce, and more particularly to a method to real-time track purchase orders and aggregate similar archived purchasing agents inputs and utilize this information to reduce the customer selling price of goods and services.

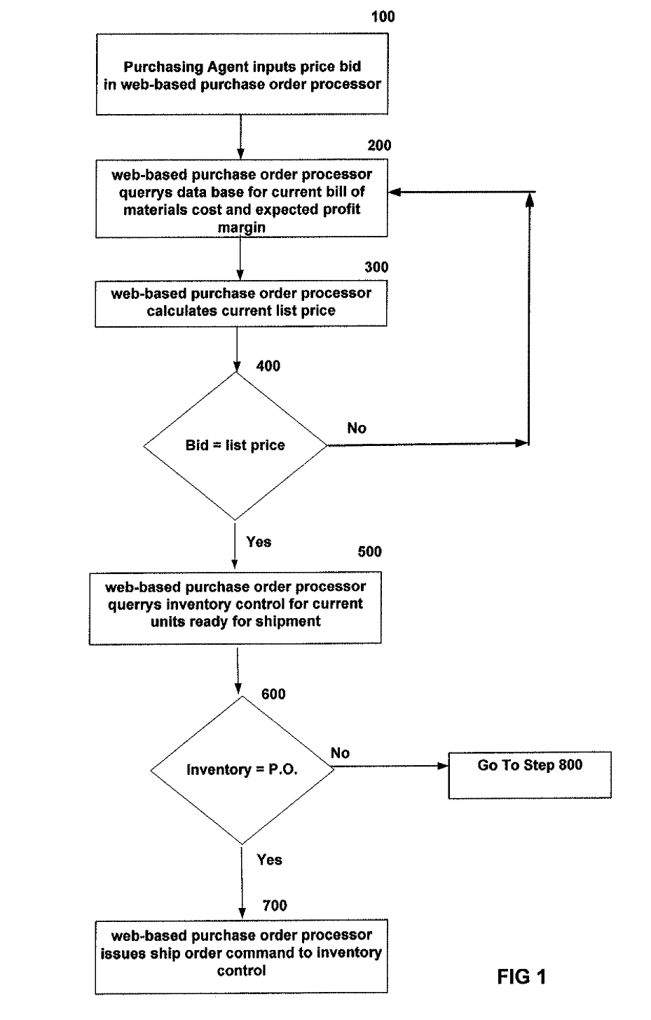

One embodiment of a web-based purchase order processor in accordance with the present invention is depicted in flowchart format in FIG. 1. As shown in FIG. 1 step 100, a purchasing agent may input a request to buy products by accessing the selling company's web-based purchase order processor. The purchase order processor may be readily available on the selling company's web site and may be accessed by the general public with no need for a password or any similar filtering techniques. As a part of entering the purchase order, the purchasing agent may review the current offering price of the product as calculated real-time by the purchase order processor in steps 200 and 300, and chose to accept the current offering price.

Alternatively, the purchasing agent may chose to input an offering or bid price for the product at a reduced price from the current list price. In this environment, the purchasing agent may be agreeable to let their reduced bid price offering “float” in the event that the bid price may match the list price at a future date. This scenario is depicted in step 400 of the flowchart in the “No” pathway.

Steps 100 through 400 of the flowchart are meant to be a cumulative process, amassing purchase orders from multiple purchasing agents. In this scenario, in step 200 of the flowchart the purchase order processor may correlate purchase orders with identical part numbers and automatically query vendors for volume discounts—thereby reducing the bill of materials cost for that particular product. In the event this process yields a reduced list price for a product, in step 400, the purchase order processor may compare all archived floating bids for that product, and all bids that match or exceed the current list price will be forwarded to processing step 500. All other floating bids which fall short of the current list price, will continue circulating through steps 200 through 400 of the processor's algorithm.

For those bids that match or exceed the current list price in step 400, following the “Yes” pathway to step 500, wherein the purchase order processor may query inventory control for current units ready for shipment that match the approved part number. In step 600, the purchase order processor may compare current inventory with purchase order demand and in the case where inventory meets or exceeds demand (the “Yes” pathway), the purchase order processor may issue a ship order command in step 700 to inventory control. Conversely, in those cases where current inventory does not meet demand (the “No” pathway in step 600) the purchase order processor may issue a web-based query in step 800 to the purchasing agent to inquire if a partial shipment is acceptable, and if given the go-ahead from the purchasing agent (the “Yes” pathway in step 900) the purchase order processor may issue a partial ship command to inventory control (step 1000). Alternatively, if the purchasing agent does not desire a partial shipment (the “No” pathway in step 900), the purchase order processor may continually query inventory control for real-time status on availability of inventory and may issue the ship order command when inventory meets demand.

The present invention should not be considered limited to the particular examples described above, but rather should be understood to cover all aspects of the invention as fairly set out in the attached claims. Various modifications, equivalent processes to which the present invention may be applicable will be readily apparent to those of skill in the art to which the present invention is directed upon review of the present specification. The following claims are intended to cover such modifications and processes.

I claim:

1. A method for processing a request to purchase goods at a specific bid price comprising:
a processor to accept said request to purchase goods over the Internet;
said processor in real-time contact with vendors to calculate current list price for purchasable goods;
said processor to accumulate multiple requests to purchase similar goods;
said processor in real-time contacts vendors to request volume discount on purchasable goods; and,
said processor to accept request to purchase goods at a specific bid price when bid price meets or exceeds current list price.

2. The method of claim 1 wherein said processor queries inventory control for current units ready for shipment.

3. The method of claim 2 wherein said processor issues a ship order command to inventory control if current supply meets demand.

4. The method of claim 2 wherein said processor queries purchasing agent if partial shipments are acceptable if current supply does not meet or exceed demand.

5. The method of claim 4 wherein said processor issues a partial ship order command to inventory control if current supply does not meet demand and purchasing agent has agreed to partial shipments.
